(19) United States
(12) Patent Application Publication
(10) Pub. No.: US 2025/0127254 A1
(43) Pub. Date: Apr. 24, 2025

(54) AUTOMATIC HAT TAKING MACHINE OF MULTI-STATION ROTATING HAT IRONING MACHINE FOR HAT MAKING INDUSTRY

(71) Applicants: QINGDAO QIANFENG CAPART INT'L CORP, QINGDAO (CN); QINGDAO DUODAI INTELLIGENT TECHNOLOGY CO.,LTD., QINGDAO (CN)

(72) Inventors: Aimei Wang, QINGDAO (CN); Zihao Wu, QINGDAO (CN)

(21) Appl. No.: 18/796,080

(22) Filed: Aug. 6, 2024

(30) Foreign Application Priority Data
Oct. 18, 2023 (CN) 202311348621.4

(51) Int. Cl. A42C 1/08

(52) U.S. Cl. CPC A42C 1/08

(57) ABSTRACT

The present invention relates to the technical field of clothing hat making industry, and specifically relates to an automatic hat taking machine of a multi-station rotating hat ironing machine for hat making industry. The automatic hat taking machine comprises an X-axis moving device, a Z-axis moving device, a Y-axis moving device, and a hat grabbing device; the Z-axis moving device that moves horizontally along an X-axis direction is installed on the X-axis moving device; the Y-axis moving device that moves up and down along a Z-axis direction is installed on the Z-axis moving device; and the hat grabbing device that moves longitudinally along a Y-axis direction is installed on the Y-axis moving device. The automatic hat taking machine can reduce the labor intensity, reduce the enterprise cost, greatly improve the working efficiency, etc.

### CROSS-REFERENCE TO RELATED APPLICATIONS

This application claims priority to Chinese Patent Application No. 202311348621.4, filed on Oct. 18, 2023, which is hereby incorporated by reference in its entirety.

### TECHNICAL FIELD

The present invention relates to the technical field of clothing hat making industry, and specifically relates to an automatic hat taking machine of a multi-station rotating hat ironing machine for hat making industry.

### BACKGROUND

In a hat making production process, our company has the situation of needing to depend on manual hat feeding during hat ironing, leading to high labor intensity of operators. Because more persons are needed, the enterprise cost is increased by intensive persons, which is not conducive to controlling the production cost of hats in a later period. Therefore, our company has made innovations for the above problems and adopted and designed an apparatus capable of realizing hat feeding, so as to solve the above problems.

### SUMMARY

The purpose of the present invention is to provide an automatic hat taking machine of a multi-station rotating hat ironing machine for the hat making industry in view of defects and disadvantages of the prior art.

The automatic hat taking machine of a multi-station rotating hat ironing machine for the hat making industry in the present invention comprises an X-axis moving device, a Z-axis moving device, a Y-axis moving device, and a hat grabbing device;
the Z-axis moving device that moves horizontally along an X-axis direction is installed on the X-axis moving device; the Y-axis moving device that moves up and down along a Z-axis direction is installed on the Z-axis moving device; and the hat grabbing device that moves longitudinally along a Y-axis direction is installed on the Y-axis moving device.

Further, the X-axis moving device comprises a frame body, a rectangular hole is formed in the middle of a surface of the frame body, X-axis linear guide rail fixing plates are installed on left and right sides of a top surface of the rectangular hole respectively, X-axis linear guide rails are installed on the X-axis linear guide rail fixing plates, two X-axis sliding blocks are installed on the two X-axis linear guide rails respectively, and the four X-axis sliding blocks are installed on two sides of a bottom surface of an X-axis moving plate and are of a two-row and two-column arrangement structure;

X-axis tightening seats are installed in the middle of a front end of the top surface of the rectangular hole, an X-axis driven shaft is installed between the X-axis tightening seats, an X-axis driven synchronous pulley wheel blocking sleeve is installed on the X-axis driven shaft, an X-axis driven synchronous pulley bearing is installed on the X-axis driven synchronous pulley wheel blocking sleeve, and an X-axis driven synchronous wheel is installed on the X-axis driven synchronous pulley bearing; an X-axis driving servo motor fixing seat is installed on one side of a rear end of the top surface of the rectangular hole, an X-axis driving servo motor is installed on the X-axis driving servo motor fixing seat, and an X-axis driving wheel is installed on a motor shaft of the X-axis driving servo motor; an X-axis power transmission synchronous belt is installed on the X-axis driving wheel and the X-axis driven synchronous wheel; an X-axis power transmission synchronous belt pressing plate is installed in the X-axis power transmission synchronous belt, the X-axis power transmission synchronous belt pressing plate faces the bottom surface of the X-axis moving plate, and the bottom surface of the X-axis moving plate is connected to the X-axis power transmission synchronous belt;
a proximity switch fixing plate is installed in the middle of an outer side of the X-axis linear guide rail fixing plate on the left side of the frame body; and a left tightening plate and a right tightening plate are installed on two sides of rear portions of the X-axis tightening seats respectively, and the left tightening plate and the right tightening plate are arranged on two sides of the X-axis power transmission synchronous belt respectively.

Further, floor casters are installed at four corners of a bottom surface of the frame body respectively.

Further, the Z-axis moving device comprises a fixing frame, the fixing frame is rectangular, Z-axis linear guide rails are installed on left and right sides of a front surface of the fixing frame respectively, Z-axis sliding blocks are installed on the two Z-axis linear guide rails, and a Z-axis movable plate is installed on the Z-axis sliding blocks;
a Z-axis driven synchronous pulley installing plate is installed at a top end of the fixing frame, a Z-axis driven synchronous pulley shaft is installed on the Z-axis driven synchronous pulley installing plate, a Z-axis driven synchronous pulley bearing is installed on the Z-axis driven synchronous pulley shaft, and a Z-axis driven synchronous pulley is installed on the Z-axis driven synchronous pulley bearing; a Z-axis servo motor fixing seat is installed at a bottom end of a back surface of the fixing frame, a Z-axis driving servo motor is installed on the Z-axis servo motor fixing seat, and a shaft driving synchronous pulley is installed on the Z-axis driving servo motor; a Z-axis driving synchronous belt is installed on the shaft driving synchronous pulley and the Z-axis driven synchronous pulley, and a Z-axis synchronous belt pressing plate is installed on the Z-axis driving synchronous belt;
and connecting plates are correspondingly installed on two sides of a back surface of the Z-axis movable plate, a synchronous belt fixing inner plate is installed on outer end surfaces of the two connecting plates, and the synchronous belt fixing inner plate faces the Z-axis synchronous belt pressing plate.

Further, the Y-axis moving device comprises two connecting plates that are installed at an upper portion and a lower portion of a surface of the Z-axis movable plate of the Z-axis moving device respectively, and the four connecting plates are of a two-row and two-column arrangement structure; one Y-axis linear guide rail is installed on the two connecting plates at the upper portion and the two connecting plates at the lower portion of the Z-axis movable plate respectively, and the two Y-axis linear guide rails form a slideway;
a Y-axis driven synchronous pulley seat is installed on one side of a back surface of the slideway, a Y-axis driven synchronous pulley shaft is installed on the Y-axis driven synchronous pulley seat, a Y-axis driven synchronous pulley bearing is installed on the Y-axis driven synchronous pulley shaft, and a Y-axis driven synchronous pulley is installed on the Y-axis driven synchronous pulley bearing; a Y-axis driving servo motor fixing seat is installed on the other side of the slideway, a Y-axis driving servo motor is installed on the Y-axis driving servo motor fixing seat, and a Y-axis driving synchronous pulley is installed at a motor shaft end of the Y-axis driving servo motor; a Y-axis driving synchronous belt is installed on the Y-axis driving synchronous pulley and the Y-axis driven synchronous pulley;
a Y-axis driving synchronous belt pressing plate is installed on the Y-axis driving synchronous belt; a Y-axis sliding block is installed on the two Y-axis linear guide rails of the slideway, a Y-axis front fixing plate is installed on the Y-axis sliding block, and a number of installing holes are formed on the Y-axis front fixing plate;
and on the slideway, Y-axis driven synchronous pulley seat tightening blocks are installed at upper and lower portions of an inner side of the Y-axis driven synchronous pulley seat respectively to realize adjustment of the Y-axis driving synchronous belt.

Further, the hat grabbing device comprises a rotating driving servo motor fixing seat installed on the Y-axis front fixing plate, the rotating driving servo motor fixing seat is in an inverted L shape, and a rotating driving servo motor shaft hole is formed at a horizontal surface portion of the rotating driving servo motor fixing seat; a rotating driving servo motor is installed on a bottom surface of the horizontal surface portion of the rotating driving servo motor fixing seat, and a motor shaft of the rotating driving servo motor penetrates through the rotating driving servo motor shaft hole and is connected to a bottom surface of a swing mechanism driving servo fixing seat;
the swing mechanism driving servo fixing seat is in an L shape, and a swing mechanism driving servo motor is installed on a back surface of a vertical surface portion of the swing mechanism driving servo fixing seat; a motor shaft of the swing mechanism driving servo motor is connected to a driving synchronous pulley that is installed on one side of a front surface of the vertical surface portion of the swing mechanism driving servo fixing seat, and the driving synchronous pulley is connected to a driven synchronous pulley through a driving synchronous belt; the driven synchronous pulley is installed on the other side of the front surface of the vertical surface portion of the swing mechanism driving servo fixing seat; an upper portion of the front surface of the vertical surface portion of the swing mechanism driving servo fixing seat is provided with an elliptical adjustment hole, and a tightening wheel is installed on the elliptical adjustment hole;
a bearing installing plate is installed on one side of a horizontal surface portion of the swing mechanism driving servo fixing seat, and a bearing is installed on the bearing installing plate; two hat grabbing finger cylinder fixing plates are installed on an inner side of the bearing installing plate, the hat grabbing finger cylinder fixing plates are installed on two sides of a hat grabbing finger cylinder, one hat grabbing finger cylinder fixing plate is connected to an inner end head of a wheel shaft of the driven synchronous pulley, the other hat grabbing finger cylinder fixing plate is connected to the other shaft rod, and the other shaft rod is installed in the bearing; a clamp is installed on the hat grabbing finger cylinder; and a fixing sleeve is installed at a connection of the rotating driving servo motor and a bottom surface of the horizontal surface portion of the swing mechanism driving servo fixing seat.

Beneficial effects of the present invention are that the automatic hat taking machine of a multi-station rotating hat ironing machine for the hat making industry in the present invention overcomes the situation that hat ironing depends on manual hat feeding in the industry, and has the advantages of being simple in structure, convenient to install, capable of reducing labor intensity, reducing enterprise cost and greatly improving working efficiency and the like.

### BRIEF DESCRIPTION OF DRAWINGS

Accompanying drawings described herein are used to provide a further understanding of the present invention and constitute a part of the present application, but do not constitute improper limitations of the present invention. In the accompanying drawings:

FIG. 1 is a three-dimensional structural schematic diagram of the present invention;

FIG. 2 is a three-dimensional structural schematic diagram of an X-axis moving device in one direction in the present invention;

FIG. 3 is a three-dimensional structural schematic diagram of the X-axis moving device in another direction in the present invention;

FIG. 4 is a three-dimensional structural schematic diagram of a Z-axis moving device in one direction in the present invention;

FIG. 5 is a three-dimensional structural schematic diagram of the Z-axis moving device in another direction in the present invention;

FIG. 6 is a three-dimensional structural schematic diagram of a Y-axis moving device in one direction in the present invention;

FIG. 7 is a three-dimensional structural schematic diagram of the Y-axis moving device in another direction in the present invention;

FIG. 8 is a three-dimensional structural schematic diagram of a hat grabbing device D in one direction in the present invention;

FIG. 9 is a three-dimensional structural schematic diagram of the hat grabbing device D in another direction in the present invention; and

FIG. 10 is a three-dimensional structural schematic diagram of the hat grabbing device D in another direction in the present invention.

Numerals are described as follows:

X-axis moving device—A; floor caster—1; frame body—2; X-axis driving servo motor—3; X-axis driving servo motor fixing seat—4; X-axis linear guide rail fixing plate—5; X-axis linear guide rail—6; right tightening plate—7; proximity switch fixing plate—8; X-axis sliding block—9; X-axis moving plate—10; left tightening plate—11; X-axis tightening seat—12; X-axis driven shaft—13; X-axis driven synchronous pulley wheel blocking sleeve—14; X-axis driven synchronous wheel—15; X-axis driven synchronous pulley bearing—16; X-axis driving wheel—17; X-axis power transmission synchronous belt—18; X-axis power transmission synchronous belt pressing plate—19;

Z-axis moving device—B; fixing frame—20; Z-axis driving servo motor—21; Z-axis servo motor fixing seat—22; Z-axis driven synchronous pulley installing plate—23; Z-axis driven synchronous pulley shaft—24; Z-axis driving synchronous belt—25; Z-axis driving synchronous pulley—26; Z-axis driven synchronous pulley—27; Z-axis driven synchronous pulley bearing—28; connecting plate—29; synchronous belt fixing inner plate—30; Z-axis synchronous belt pressing plate—31; Z-axis linear guide rail—32; Z-axis sliding block—33; Z-axis movable plate—34;

Y-axis moving device—C; Y-axis driving servo motor—35; Y-axis driving servo motor fixing seat—36; Y-axis driving synchronous pulley—37; Y-axis driven synchronous pulley—38; Y-axis driven synchronous pulley bearing—39; Y-axis driven synchronous pulley shaft—40; Y-axis driven synchronous pulley seat—41; Y-axis driven synchronous pulley seat tightening block—42; Y-axis driving synchronous belt—43; connecting plate—44; Y-axis driving synchronous belt pressing plate—45; Y-axis front fixing plate—46; Y-axis linear guide rail—47; Y-axis sliding block—48;
hat grabbing device—D; swing mechanism driving servo motor—49; swing mechanism driving servo fixing seat—50; hat grabbing finger cylinder—51; rotating driving servo motor fixing seat—52; rotating driving servo motor—53; driving synchronous pulley—54; driven synchronous pulley—55; driving synchronous belt—56; tightening wheel—57; bearing installing plate—58; hat grabbing finger cylinder fixing plate—59; fixing sleeve—60; bearing—61; clamp—62.

### DETAILED DESCRIPTION OF THE EMBODIMENTS

The present invention is described in detail below with reference to the accompanying drawings and specific embodiments, in which the illustrative embodiments and descriptions are only used to explain the present invention, but are not used as limitations of the present invention.

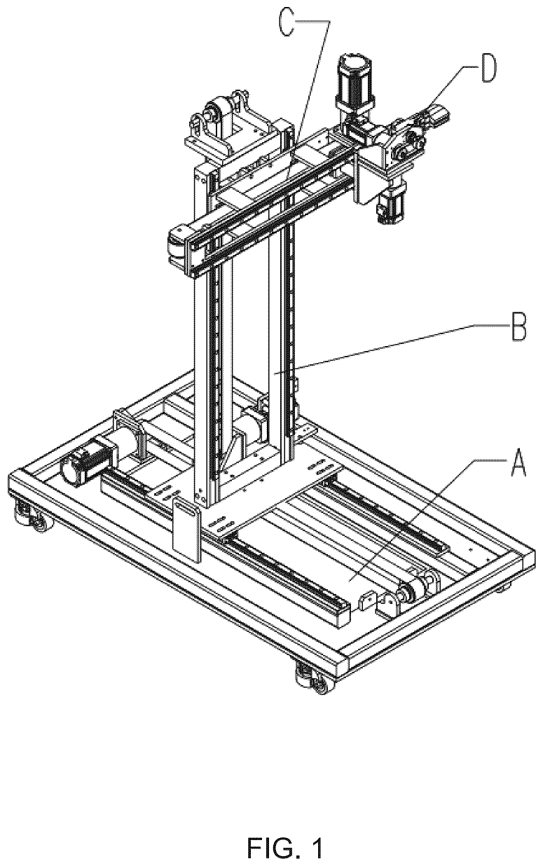

As shown in FIG. 1, an automatic hat taking machine of a multi-station rotating hat ironing machine for the hat making industry in a specific embodiment comprises an X-axis moving device A, a Z-axis moving device B, a Y-axis moving device C, and a hat grabbing device D; the Z-axis moving device B that moves horizontally along an X-axis direction is installed on the X-axis moving device A; the Y-axis moving device C that moves up and down along a Z-axis direction is installed on the Z-axis moving device B; and the hat grabbing device D that moves longitudinally along a Y-axis direction is installed on the Y- axis moving device C.

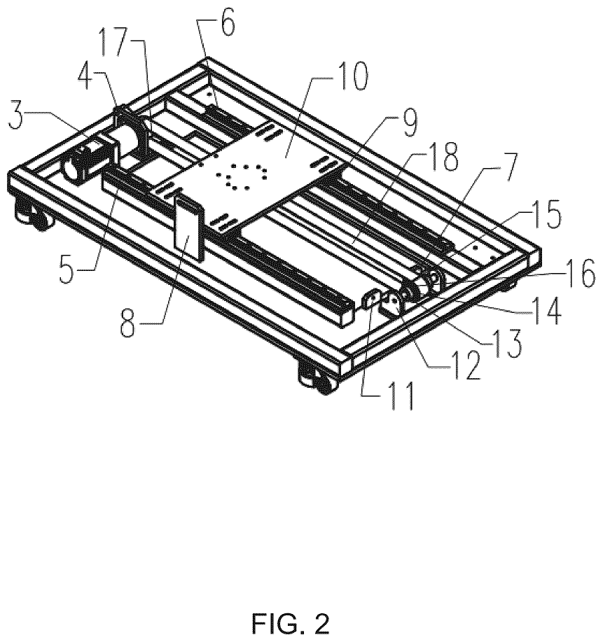

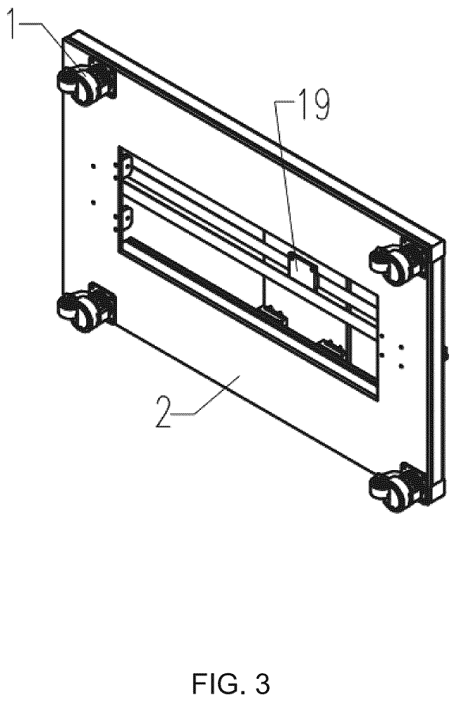

Further, as shown in FIG. 2 to FIG. 3, the X-axis moving device A comprises a frame body 2, a rectangular hole is formed in the middle of a surface of the frame body 2, X-axis linear guide rail fixing plates 5 are installed on left and right sides of a top surface of the rectangular hole respectively, X-axis linear guide rails 6 are installed on the X-axis linear guide rail fixing plates 5, two X-axis sliding blocks 9 are installed on the two X-axis linear guide rails 6 respectively, and the four X-axis sliding blocks 9 are installed on two sides of a bottom surface of an X-axis moving plate 10 and are of a two-row and two-column arrangement structure;

X-axis tightening seats 12 are installed in the middle of a front end of the top surface of the rectangular hole, an X-axis driven shaft 13 is installed between the X-axis tightening seats 12, an X-axis driven synchronous pulley wheel blocking sleeve 14 is installed on the X-axis driven shaft 13, an X-axis driven synchronous pulley bearing 16 is installed on the X-axis driven synchronous pulley wheel blocking sleeve 14, and an X-axis driven synchronous wheel 15 is installed on the X-axis driven synchronous pulley bearing 16; an X-axis driving servo motor fixing seat 4 is installed on one side of a rear end of the top surface of the rectangular hole, an X-axis driving servo motor 3 is installed on the X-axis driving servo motor fixing seat 4, and an X-axis driving wheel 17 is installed on a motor shaft of the X-axis driving servo motor 3; an X-axis power transmission synchronous belt 18 is installed on the X-axis driving wheel 17 and the X-axis driven synchronous wheel 15; an X-axis power transmission synchronous belt pressing plate 19 is installed in the X-axis power transmission synchronous belt 18, the X-axis power transmission synchronous belt pressing plate 19 faces the bottom surface of the X-axis moving plate 10, and the bottom surface of the X-axis moving plate 10 is connected to the X-axis power transmission synchronous belt 18;
a proximity switch fixing plate 8 is installed in the middle of an outer side of the X-axis linear guide rail fixing plate 5 on the left side of the frame body 2; and a left tightening plate 11 and a right tightening plate 7 are installed on two sides of rear portions of the X-axis tightening seats 12 respectively, and the left tightening plate 11 and the right tightening plate 7 are arranged on two sides of the X-axis power transmission synchronous belt 18 respectively.

Further, as shown in FIG. 3, floor casters 1 are installed at four corners of a bottom surface of the frame body 2 respectively.

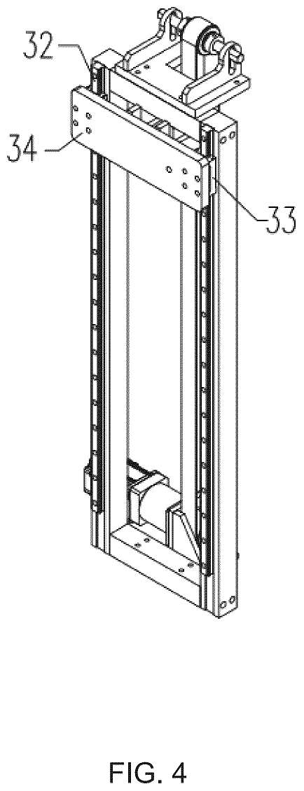

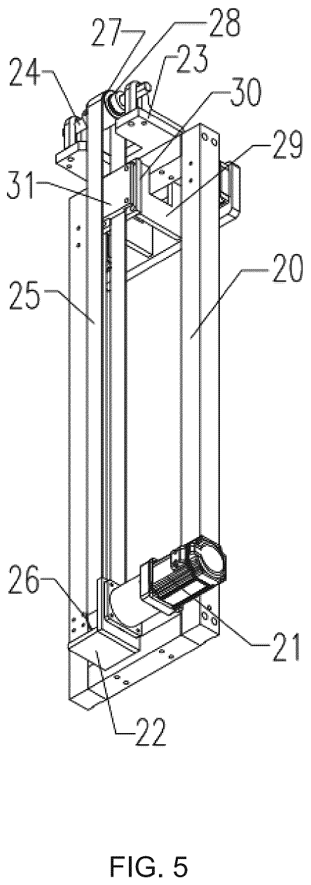

Further, as shown in FIG. 4 to FIG. 5, the Z-axis moving device B comprises a fixing frame 20, the fixing frame 20 is rectangular, Z-axis linear guide rails 32 are installed on left and right sides of a front surface of the fixing frame 20 respectively, a Z-axis sliding block 33 is installed on the two Z-axis linear guide rails 32, and a Z-axis movable plate 34 is installed on the Z-axis sliding block 33;
a Z-axis driven synchronous pulley installing plate 23 is installed at a top end of the fixing frame 20, a Z-axis driven synchronous pulley shaft 24 is installed on the Z-axis driven synchronous pulley installing plate 23, a Z-axis driven synchronous pulley bearing 28 is installed on the Z-axis driven synchronous pulley shaft 24, and a Z-axis driven synchronous pulley 27 is installed on the Z-axis driven synchronous pulley bearing 28; a Z-axis servo motor fixing seat 22 is installed at a bottom end of a back surface of the fixing frame 20, a Z-axis driving servo motor 21 is installed on the Z-axis servo motor fixing seat 22, and a shaft driving synchronous pulley 26 is installed on the Z-axis driving servo motor 21; a Z-axis driving synchronous belt 25 is installed on the shaft driving synchronous pulley 26 and the Z-axis driven synchronous pulley 27, and a Z-axis synchronous belt pressing plate 31 is installed on the Z-axis driving synchronous belt 25;
and connecting plates 29 are correspondingly installed on two sides of a back surface of the Z-axis movable plate 34, a synchronous belt fixing inner plate 30 is installed on outer end surfaces of the two connecting plates 29, and the synchronous belt fixing inner plate 30 faces the Z-axis synchronous belt pressing plate 31.

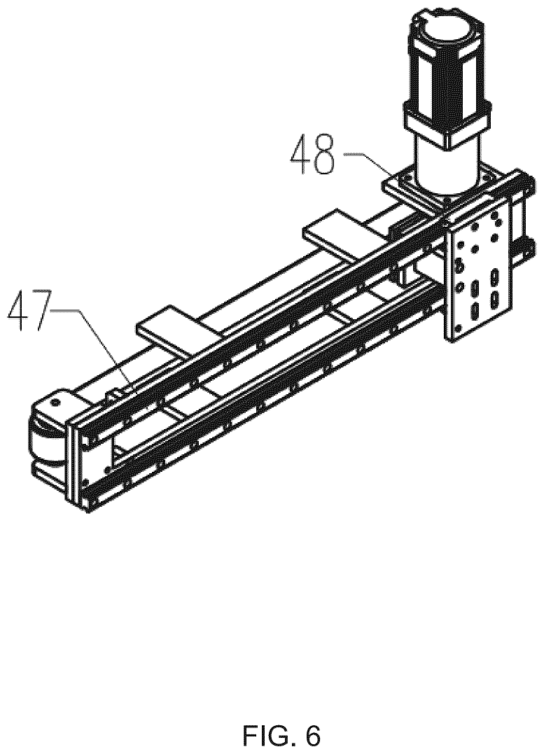

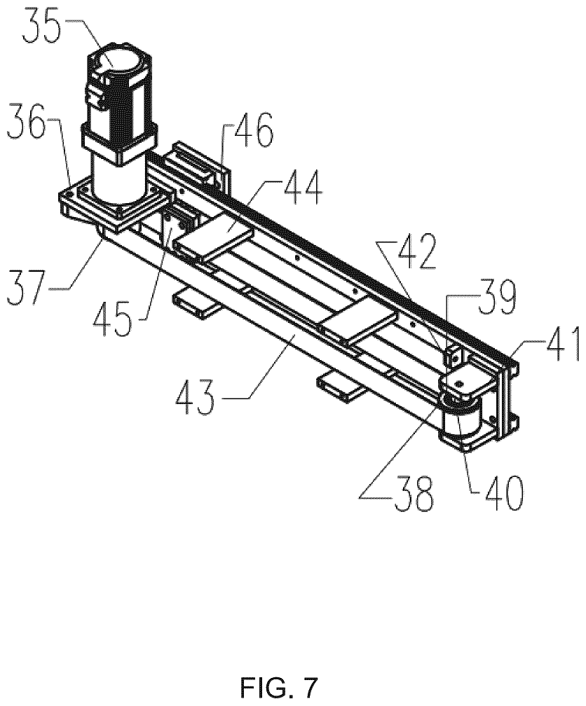

Further, as shown in FIG. 6 to FIG. 7, the Y-axis moving device C comprises two connecting plates 44 that are installed at an upper portion and a lower portion of a surface of the Z-axis movable plate 34 of the Z-axis moving device B respectively, and the four connecting plates 44 are of a two-row and two-column arrangement structure; one Y-axis linear guide rail 47 is installed on the two connecting plates 44 at the upper portion and the two connecting plates 44 at the lower portion of the Z-axis movable plate 34 respectively, and the two Y-axis linear guide rails 47 form a slideway;
a Y-axis driven synchronous pulley seat 41 is installed on one side of a back surface of the slideway, a Y-axis driven synchronous pulley shaft 40 is installed on the Y-axis driven synchronous pulley seat 41, a Y-axis driven synchronous pulley bearing 39 is installed on the Y-axis driven synchronous pulley shaft 40, and a Y-axis driven synchronous pulley 38 is installed on the Y-axis driven synchronous pulley bearing 39; a Y-axis driving servo motor fixing seat 36 is installed on the other side of the slideway, a Y-axis driving servo motor 35 is installed on the Y-axis driving servo motor fixing seat 36, and a Y-axis driving synchronous pulley 37 is installed at a motor shaft end of the Y-axis driving servo motor 35; a Y-axis driving synchronous belt 43 is installed on the Y-axis driving synchronous pulley 37 and the Y-axis driven synchronous pulley 38;
a Y-axis driving synchronous belt pressing plate 45 is installed on the Y-axis driving synchronous belt 43; a Y-axis sliding block 48 is installed on the two Y-axis linear guide rails 47 of the slideway, a Y-axis front fixing plate 46 is installed on the Y-axis sliding block 48, and a number of installing holes are formed on the Y-axis front fixing plate 46;
and on the slideway, Y-axis driven synchronous pulley seat tightening blocks 42 are installed at upper and lower portions of an inner side of the Y-axis driven synchronous pulley seat 41 respectively to realize adjustment of the Y-axis driving synchronous belt 43.

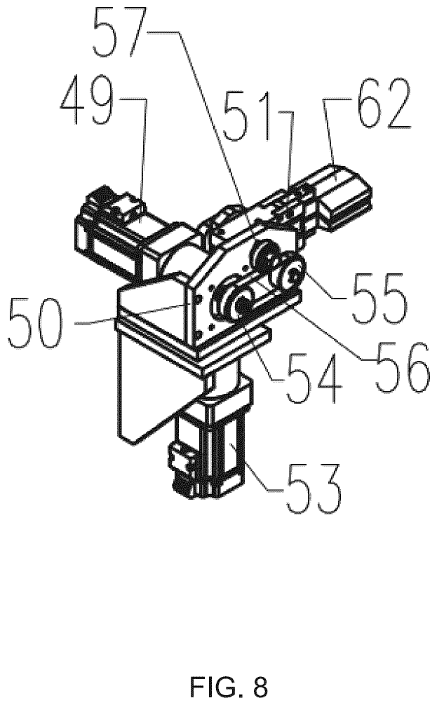

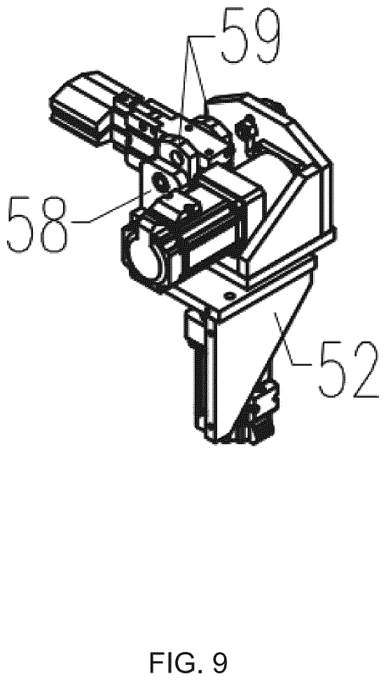

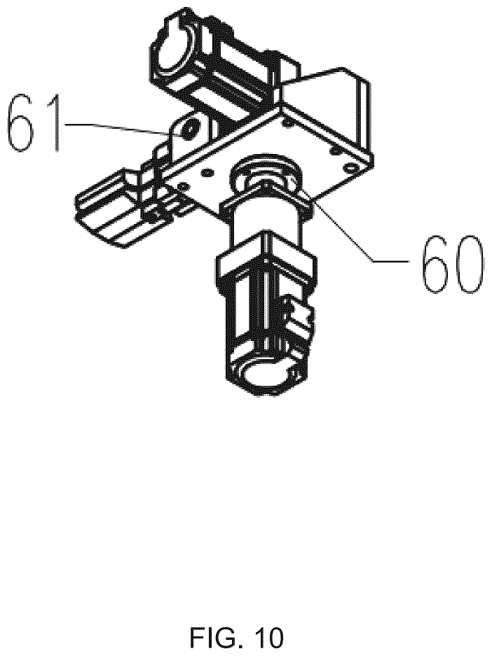

Further, as shown in FIG. 8 to FIG. 10, the hat grabbing device D comprises a rotating driving servo motor fixing seat 52 installed on the Y-axis front fixing plate 46, the rotating driving servo motor fixing seat 52 is in an inverted L shape, and a rotating driving servo motor shaft hole is formed at a horizontal surface portion of the rotating driving servo motor fixing seat 52; a rotating driving servo motor 53 is installed on a bottom surface of the horizontal surface portion of the rotating driving servo motor fixing seat 52, and a motor shaft of the rotating driving servo motor 53 penetrates through the rotating driving servo motor shaft hole and is connected to a bottom surface of a swing mechanism driving servo fixing seat 50;
the swing mechanism driving servo fixing seat 50 is in an L shape, and a swing mechanism driving servo motor 49 is installed on a back surface of a vertical surface portion of the swing mechanism driving servo fixing seat 50; a motor shaft of the swing mechanism driving servo motor 49 is connected to a driving synchronous pulley 54 that is installed on one side of a front surface of the vertical surface portion of the swing mechanism driving servo fixing seat 50, and the driving synchronous pulley 54 is connected to a driven synchronous pulley 55 through a driving synchronous belt 56; the driven synchronous pulley 55 is installed on the other side of the front surface of the vertical surface portion of the swing mechanism driving servo fixing seat 50; an upper portion of the front surface of the vertical surface portion of the swing mechanism driving servo fixing seat 50 is provided with an elliptical adjustment hole, and a tightening wheel 57 is installed on the elliptical adjustment hole;
a bearing installing plate 58 is installed on one side of a horizontal surface portion of the swing mechanism driving servo fixing seat 50, and a bearing 61 is installed on the bearing installing plate 58; two hat grabbing finger cylinder fixing plates 59 are installed on an inner side of the bearing installing plate 58, the hat grabbing finger cylinder fixing plates 59 are installed on two sides of a hat grabbing finger cylinder 51, one hat grabbing finger cylinder fixing plate 59 is connected to an inner end head of a wheel shaft of the driven synchronous pulley 55, the other hat grabbing finger cylinder fixing plate 59 is connected to another shaft rod, and the other shaft rod is installed in the bearing 61; a clamp 62 is installed on the hat grabbing finger cylinder 51; and a fixing sleeve 60 is installed at a connection between the rotating driving servo motor 53 and a bottom surface of the horizontal surface portion of the swing mechanism driving servo fixing seat 50.

A working principle of the present invention is as follows.

The design is a hat taking machine that is designed to solve the problem of automatically grabbing hats in a hat making process. In order to conveniently control the hat grabbing device to achieve three-dimensional movement, the X-axis moving device A, the Z-axis moving device B and the Y-axis moving device C are provided to realize movement in the X-axis direction, the Y-axis direction and the Z-axis direction, thereby achieving movement at any position. Details are as follows.

In the design, the floor casters 1 are installed at the four corners of the bottom surface of the frame body 2 respectively, such that rapid movement can be achieved.

In the design, the X-axis driving servo motor 3 drives the X-axis driving wheel 17 to work, the X-axis driving wheel 17 drives the X-axis power transmission synchronous belt 18 to work, the X-axis power transmission synchronous belt 18 drives the X-axis moving plate 10 to move, and the X-axis moving plate 10 moves horizontally along the X-axis direction on the X-axis linear guide rail 6, thereby driving the Z-axis moving device B installed on the X-axis moving plate 10 to move synchronously along the X-axis direction.

In the design, the Z-axis driving servo motor 21 drives the Z-axis driving synchronous pulley 26 to work, the Z-axis driving synchronous pulley 26 drives the Z-axis driving synchronous belt 25 to work, the Z-axis driving synchronous belt 25 drives the Z-axis movable plate 34 to move, and the Z-axis movable plate 34 moves along the Z-axis direction on the Z-axis linear guide rail 32 through the Z-axis sliding block 33 on the bottom surface.

In the design, the Y-axis driving servo motor 35 works and drives the Y-axis driving synchronous pulley 37 to work, the Y-axis driving synchronous pulley 37 drives the Y-axis driving synchronous belt 43 to work, the Y-axis driving synchronous belt 43 drives the Y-axis front fixing plate 46 to work, and the Y-axis front fixing plate 46 moves along the Y-axis direction on the Y-axis linear guide rail 47 through the Y-axis sliding block 48 thereon.

Therefore, the design can achieve movement in the X-axis direction, the Z-axis direction and the Y-axis direction by controlling the X-axis driving servo motor 3, the Z-axis driving servo motor 21 and the Y-axis driving servo motor 35. Accordingly, positioning of three-dimensional positions can be achieved.

The hat grabbing device D in the design is installed on the Y-axis front fixing plate 46. Thus, the hat grabbing device D can also achieve precise position movement in the X-axis direction, the Z-axis direction and the Y-axis direction.

During use of the hat grabbing device D in the design, the hat grabbing finger cylinder fixing plates 59 control opening and closing of the clamp 62, the servo motor 49 enables the clamp 62 to have an action of pressing a hat downward, a downward angle of 0°-90° is generated in a horizontal direction, and the hat is put on a supporting hat ironing machine apparatus of our company.

The servo motor 53 controls the hat grabbing device D to rotate at 180 degrees. During use, a supporting multi-layer rotatable discharge machine of our company is installed on two sides of the automatic hat taking machine in the Y-axis direction in the design respectively, such that hats on two sides can be clamped through rotation of the servo motor 53.

The automatic hat taking machine of the present invention, by designing a console (the console is not shown in the drawings in the design) and providing a PLC controller in the console for controlling the above-mentioned electrical devices to work, can control the above-mentioned various motors, the cylinder and other electronic devices to work, thereby automatically performing operations such as descending, rotating, etc.

The console in the design is connected to the electrical devices that need to be controlled through wires. Components in the design can be perforated when wiring is required, and are conducive to accessories, such as cable clips, to facilitate wiring. As said above, the PLC controller is used to control the motors and the cylinder to achieve movement. A control circuit involved is a prior art, which is not elaborated in detail in the design.

The present invention has the following advantages of being simple in structure, convenient to install, and capable of overcoming the situation that hat ironing depends on manual hat feeding in the industry, greatly improving working efficiency, reducing labor intensity and reducing enterprise cost.

The descriptions above are only preferred embodiments of the present invention. Therefore, all equivalent changes or modifications made based on features and principles described in the patent application scope of the present invention are included in the patent application scope of the present invention.

What is claimed is:

1. An automatic hat taking machine of a multi-station rotating hat ironing machine for hat making industry, characterized in that the automatic hat taking machine comprises an X-axis moving device, a Z-axis moving device, a Y-axis moving device, and a hat grabbing device; the Z-axis moving device that moves horizontally along an X-axis direction is installed on the X-axis moving device; the Y-axis moving device that moves up and down along a Z-axis direction is installed on the Z-axis moving device; and the hat grabbing device that moves longitudinally along a Y-axis direction is installed on the Y-axis moving device.

2. The automatic hat taking machine of a multi-station rotating hat ironing machine for hat making industry according to claim 1, characterized in that the X-axis moving device comprises a frame body, a rectangular hole is formed in the middle of a surface of the frame body, X-axis linear guide rail fixing plates are installed on left and right sides of a top surface of the rectangular hole respectively, X-axis linear guide rails are installed on the X-axis linear guide rail fixing plates, two X-axis sliding blocks are installed on the two X-axis linear guide rails respectively, and the four X-axis sliding blocks are installed on two sides of a bottom surface of an X-axis moving plate and are of a two-row and two-column structure;
X-axis tightening seats are installed in the middle of a front end of the top surface of the rectangular hole, an X-axis driven shaft is installed between the X-axis tightening seats, an X-axis driven synchronous pulley wheel blocking sleeve is installed on the X-axis driven shaft, an X-axis driven synchronous pulley bearing is installed on the X-axis driven synchronous pulley wheel blocking sleeve, and an X-axis driven synchronous wheel is installed on the X-axis driven synchronous pulley bearing; an X-axis driving servo motor fixing seat is installed on one side of a rear end of the top surface of the rectangular hole, an X-axis driving servo motor is installed on the X-axis driving servo motor fixing seat, and an X-axis driving wheel is installed on a motor shaft of the X-axis driving servo motor; an X-axis power transmission synchronous belt is installed on the X-axis driving wheel and the X-axis driven synchronous wheel; an X-axis power transmission synchronous belt pressing plate is installed in the X-axis power transmission synchronous belt, the X-axis power transmission synchronous belt pressing plate faces the bottom surface of the X-axis moving plate, and the bottom surface of the X-axis moving plate is connected to the X-axis power transmission synchronous belt;
a proximity switch fixing plate is installed in the middle of an outer side of the X-axis linear guide rail fixing plate on the left side of the frame body; and a left tightening plate and a right tightening plate are installed on two sides of rear portions of the X-axis tightening seats respectively, and the left tightening plate and the right tightening plate are arranged on two sides of the X-axis power transmission synchronous belt respectively.

3. The automatic hat taking machine of a multi-station rotating hat ironing machine for hat making industry according to claim 2, characterized in that floor casters are installed at four corners of a bottom surface of the frame body respectively.

4. The automatic hat taking machine of a multi-station rotating hat ironing machine for hat making industry according to claim 1, characterized in that the Z-axis moving device comprises a fixing frame, the fixing frame is rectangular, Z-axis linear guide rails are installed on left and right sides of a front surface of the fixing frame respectively, Z-axis sliding blocks are installed on the two Z-axis linear guide rails, and a Z-axis movable plate is installed on the Z-axis sliding blocks;
a Z-axis driven synchronous pulley installing plate is installed at a top end of the fixing frame, a Z-axis driven synchronous pulley shaft is installed on the Z-axis driven synchronous pulley installing plate, a Z-axis driven synchronous pulley bearing is installed on the Z-axis driven synchronous pulley shaft, and a Z-axis driven synchronous pulley is installed on the Z-axis driven synchronous pulley bearing; a Z-axis servo motor fixing seat is installed at a bottom end of a back surface of the fixing frame, a Z-axis driving servo motor is installed on the Z-axis servo motor fixing seat, and a shaft driving synchronous pulley is installed on the Z-axis driving servo motor; a Z-axis driving synchronous belt is installed on the shaft driving synchronous pulley and the Z-axis driven synchronous pulley, and a Z-axis synchronous belt pressing plate is installed on the Z-axis driving synchronous belt;
and connecting plates are correspondingly installed on two sides of a back surface of the Z-axis movable plate, a synchronous belt fixing inner plate is installed on outer end surfaces of the two connecting plates, and the synchronous belt fixing inner plate faces the Z-axis synchronous belt pressing plate.

5. The automatic hat taking machine of a multi-station rotating hat ironing machine for hat making industry according to claim 1, characterized in that the Y-axis moving device comprises two connecting plates that are installed at an upper portion and a lower portion of a surface of the Z-axis movable plate of the Z-axis moving device respectively, and the four connecting plates are of a two-row and two-column structure; one Y-axis linear guide rail is installed on the two connecting plates at the upper portion and the two connecting plates at the lower portion of the Z-axis movable plate respectively, and the two Y-axis linear guide rails form a slideway;
a Y-axis driven synchronous pulley seat is installed on one side of a back surface of the slideway, a Y-axis driven synchronous pulley shaft is installed on the Y-axis driven synchronous pulley seat, a Y-axis driven synchronous pulley bearing is installed on the Y-axis driven synchronous pulley shaft, and a Y-axis driven synchronous pulley is installed on the Y-axis driven synchronous pulley bearing; a Y-axis driving servo motor fixing seat is installed on the other side of the slideway, a Y-axis driving servo motor is installed on the Y-axis driving servo motor fixing seat, and a Y-axis driving synchronous pulley is installed at a motor shaft end of the Y-axis driving servo motor; a Y-axis driving synchronous belt is installed on the Y-axis driving synchronous pulley and the Y-axis driven synchronous pulley;
a Y-axis driving synchronous belt pressing plate is installed on the Y-axis driving synchronous belt; Y-axis sliding blocks are installed on the two Y-axis linear guide rails of the slideway, a Y-axis front fixing plate is installed on the Y-axis sliding block, and a number of installing holes are formed on the Y-axis front fixing plate; and on the slideway, Y-axis driven synchronous pulley seat tightening blocks are installed at upper and lower portions of an inner side of the Y-axis driven synchronous pulley seat respectively to realize adjustment of the Y-axis driving synchronous belt.

6. The automatic hat taking machine of a multi-station rotating hat ironing machine for hat making industry according to claim 1, characterized in that the hat grabbing device comprises a rotating driving servo motor fixing seat installed on the Y-axis front fixing plate, the rotating driving servo motor fixing seat is in an inverted L shape, and a rotating driving servo motor shaft hole is formed at a horizontal surface portion of the rotating driving servo motor fixing seat; a rotating driving servo motor is installed on a bottom surface of the horizontal surface portion of the rotating driving servo motor fixing seat, and a motor shaft of the rotating driving servo motor penetrates through the rotating driving servo motor shaft hole and is connected to a bottom surface of a swing mechanism driving servo fixing seat;
the swing mechanism driving servo fixing seat is in an L shape, and a swing mechanism driving servo motor is installed on a back surface of a vertical surface portion of the swing mechanism driving servo fixing seat; a motor shaft of the swing mechanism driving servo motor is connected to a driving synchronous pulley that is installed on one side of a front surface of the vertical surface portion of the swing mechanism driving servo fixing seat, and the driving synchronous pulley is connected to a driven synchronous pulley through a driving synchronous belt; the driven synchronous pulley is installed on the other side of the front surface of the vertical surface portion of the swing mechanism driving servo fixing seat; an upper portion of the front surface of the vertical surface portion of the swing mechanism driving servo fixing seat is provided with an elliptical adjustment hole, and a tightening wheel is installed on the elliptical adjustment hole;
a bearing installing plate is installed on one side of a horizontal surface portion of the swing mechanism driving servo fixing seat, and a bearing is installed on the bearing installing plate; two hat grabbing finger cylinder fixing plates are installed on an inner side of the bearing installing plate, the hat grabbing finger cylinder fixing plates are installed on two sides of a hat grabbing finger cylinder, one hat grabbing finger cylinder fixing plate is connected to an inner end head of a wheel shaft of the driven synchronous pulley, the other hat grabbing finger cylinder fixing plate is connected to the other shaft rod, and the other shaft rod is installed in the bearing; a clamp is installed on the hat grabbing finger cylinder; and a fixing sleeve is installed at a connection of the rotating driving servo motor and a bottom surface of the horizontal surface portion of the swing mechanism driving servo fixing seat.
